(19) United States
(12) Patent Application Publication
(10) Pub. No.: US 2020/0066217 A1
(43) Pub. Date: Feb. 27, 2020

(54) METHOD FOR DRIVING DISPLAY DEVICE AND DRIVE DEVICE THEREOF

(71) Applicants: HKC Corporation Limited, Shuitian Village, Shiyan Sub-district (CN); Chongqing HKC Optoelectronics Technology Co., Ltd., Chongqing (CN)

(72) Inventor: Chih-Tsung KANG, Chongqing (CN)

(21) Appl. No.: 16/064,391

(22) PCT Filed: Jan. 22, 2018
(86) PCT No.: PCT/CN2018/073595

§ 371 Date: Jun. 20, 2018

(30) Foreign Application Priority Data
Dec. 21, 2017 (CN) 201711396539.3

(51) Int. Cl. G09G 3/36; G09G 3/34

(52) U.S. Cl. CPC G09G 3/3607; G09G 3/3406; G09G 2360/16; G09G 2320/028; G09G 2320/0242

(57) ABSTRACT

A method for driving a display device includes: calculating average signals of sub pixel units in a zone to obtain a zone first average signal, a zone second average signal, and a zone third average signal; determining, a smallest average signal as a lowest average signal sub pixel in terms of a dominant hue out of first, second, and third hues; determining that a smallest signal of most pixel units in the zone is a hue of a sub pixel of first, second, and third; performing combined distribution of frame signals; calculating a color signal in average color space of pixel units of each zone and determining a range for an overall average color of the zone is; according to a definition range of hues and color saturation, determining zone frame times to adjust corresponding first, second, and third light source luminance; and adjusting backlight luminance.

### BACKGROUND

### Technical Field

This application relates to a method for designing a display panel, and in particular, to a method for driving a display device and a drive device thereof.

### Related Art

A liquid-crystal display (LCD) is a flat thin display device, includes a quantity of color or black and white pixels, and is disposed in front of a light source or a reflecting surface. Each pixel includes the following parts: a liquid crystal molecular layer suspending between two transparent electrodes, and two polarization filters whose polarization directions are perpendicular to each other and that are disposed on two outer sides. If there is no liquid crystal between the electrodes, when light passes through one of the polarization filters, a polarization direction of the polarization filter is completely perpendicular to that of the other polarization filter. Therefore, the light is completely blocked. However, if the polarization direction of the light passing through one of the polarization filters is rotated by a liquid crystal, the light can pass through the other polarization filter. Rotation of the polarization direction of the light by the liquid crystal may be controlled by using an electrostatic field, so as to implement control over the light.

Before charges are applied to transparent electrodes, arrangement of the liquid crystal molecules is determined by arrangement on surfaces of the electrodes. Surfaces of chemical substances of the electrodes may be used as seeds of crystal. In a most common twisted nematic (TN) liquid crystal, two electrodes above and below the liquid crystal are perpendicularly arranged. Liquid crystal molecules are arranged in a spiral manner. A polarization direction of light passing through one of polarization filters rotates after the light passes through a liquid crystal sheet, so that the light can pass through the other polarization filter. In this process, a small part of light is blocked by the polarization filter, and looks gray when being seen from outside. After the charges are applied to the transparent electrodes, the liquid crystal molecules are almost completely arranged in parallel along an electric field direction. Therefore, a polarization direction of light passing through one of polarization filters does not rotate. Therefore the light is completely blocked. In this case, a pixel looks black. A twisting degree of arrangement of the liquid crystal molecules can be controlled by means of voltage control, so as to achieve different grayscales.

Because the liquid crystal does not have colors, a color filter is used to generate various colors, and is a key component for turning grayscales into colors of an LCD. A backlight module in the LCD provides a light source, and then grayscale display is formed by means of a drive IC and liquid crystal control, and the light source passes through a color resist layer of the color filter to form a color display image.

### SUMMARY

To resolve the foregoing technical problem, an objective of this applications is to provide a method for designing a display panel, and in particular, a method for driving a display device, including: calculating average signals of sub pixel units in a zone to obtain a zone first average signal, a zone second average signal, and a zone third average signal; determining, according to the average signals in the zone, a smallest average signal as a lowest average signal sub pixel in terms of a dominant hue out of first, second, and third hues; determining that a smallest signal of most pixel units in the zone is a hue of a sub pixel of first, second, and third; performing combined distribution of frame signals; calculating a color signal in average color space of pixel units of each zone and determining a range for an overall average color of the zone is; according to a definition range of hues and color saturation, determining zone frame times to adjust corresponding first, second, and third light source luminance; and adjusting backlight luminance.

The objective of this application is achieved and the technical problem of this application is resolved by using the following technical solutions. A method for driving a display device provided according to this application includes: calculating average signals of sub pixel units in a zone to obtain a zone first average signal, a zone second average signal, and a zone third average signal; determining, according to the average signals in the zone, a smallest average signal as a lowest average signal sub pixel in terms of a dominant hue out of first, second, and third hues; determining that a smallest signal of most pixel units in the zone is a hue of a sub pixel of first, second, and third; performing combined distribution of frame signals; calculating a color signal in average color space of pixel units of each zone and determining a range for an overall average color of the zone is; according to a definition range of hues and color saturation, determining zone frame times to adjust corresponding first, second, and third light source luminance; and adjusting backlight luminance.

The objective of this application may further be achieved and the technical problem of this application may further be resolved by using the following technical solutions.

Another objective of this application is a device for driving a display device, comprising at least one zone, where each zone comprises a plurality of pixel units, each pixel unit comprises a first sub pixel unit, a second sub pixel unit, and a third sub pixel unit, and the device for driving a display device comprises: calculating average signals of sub pixel units in a zone to obtain a zone first average signal, a zone second average signal, and a zone third average signal; determining, according to the average signals in the zone, a smallest average signal as a lowest average signal sub pixel in terms of a dominant hue out of first, second, and third hues; determining that a smallest signal of most pixel units in the zone is a hue of a sub pixel of first, second, and third; performing combined distribution of frame signals; calculating a color signal in average color space of pixel units of each zone and determining a range for an overall average color of the zone is; according to a definition range of hues and color saturation, determining zone frame times to adjust corresponding first, second, and third light source luminance; and adjusting backlight luminance.

Still another objective of this application is a device for driving a display device, comprising at least one zone, where each zone comprises a plurality of pixel units, each pixel unit comprises a first sub pixel unit, a second sub pixel unit, and a third sub pixel unit, and the device for driving a display device comprises: calculating average signals of sub pixel units in a zone to obtain a zone first average signal, a zone second average signal, and a zone third average signal; determining, according to the average signals in the zone, a smallest average signal as a lowest average signal sub pixel in terms of a dominant hue out of first, second, and third hues; determining that a smallest signal of most pixel units in the zone is a hue of a sub pixel of first, second, and third; performing combined distribution of frame signals; calculating a color signal in average color space of pixel units of each zone and determining a range for an overall average color of the zone is; according to a definition range of hues and color saturation, determining zone frame times to adjust corresponding first, second, and third light source luminance; and adjusting backlight luminance, where the definition range based on hues and color saturation is a first condition range, a range based on magnitudes of zone average values is a second condition range, and therefore, the zone frame times are determined to adjust the corresponding first, second, and third light source luminance; the first sub pixel unit, the second sub pixel unit, and the third sub pixel unit are arranged in an array.

In an embodiment of this application, the average signals of pixel units in a zone are a first hue combination of the first average signal, the second average signal, and the third average signal, and the first average signal is greater than the second average signal, and the second average signal is greater than the third average signal; when a group of pixel units in the zone is a first hue combination of a first pixel unit, a second pixel unit, and a third pixel unit, when a grayscale signal that the first pixel unit is greater than the second pixel unit, and the second pixel unit is greater than the third pixel unit has a same order as a grayscale signal that the first average signal is greater than the second average signal, and the second average signal is greater than the third average signal in the first hue combination of the average signals, that is, the first average signal, the second average signal, and the third average signal, of the zone, a smallest common signal of the first pixel unit, the second pixel unit, and the third pixel unit of the sub pixel unit is the third pixel unit.

In an embodiment of this application, the grayscale signal of the first pixel unit, the second pixel unit, and the third pixel unit of the sub pixel unit turns into a signal combination of three frames from one frame, respectively, a frame 1 being a combination of a first pixel unit, a first second pixel unit, and a first third pixel unit, a frame 2 being a combination of a second first pixel unit, a second pixel unit, and a second third pixel unit, and a frame 3 being a combination of a third first pixel unit, a third second pixel unit, and a third pixel unit, where the signal combination of the frame 1, the frame 2, and the frame 3 satisfy that a sum of the first pixel unit, the second first pixel unit, and the third first pixel unit is equal to the first pixel unit, a sum of the first second pixel unit, the second pixel unit, and the third second pixel unit is equal to the second pixel unit, and a sum of the first third pixel unit, the second third pixel unit, and the third pixel unit is equal to the third pixel unit.

In an embodiment of this application, the combination 1 of the first pixel unit, the first second pixel unit, and the first third pixel unit of a sub pixel signal of the frame 1 uses a smallest color third pixel unit pixel signal third pixel unit of the sub pixel unit as a common sub pixel signal of the frame, that is, the first pixel unit is equal to the third pixel unit, the first second pixel unit is equal to the third pixel unit, and the first third pixel unit is equal to the third pixel unit.

In an embodiment of this application, the second first pixel unit, the second second pixel unit, and the second third pixel unit of a sub pixel signal of the frame 2 are a sub pixel color of a common sub pixel signal of a difference between the first pixel unit, the second pixel unit, and the third pixel unit of an original signal and the signal of the frame 1, that is, first, second, and third sub pixel difference signals are respectively the first pixel unit—the third pixel unit, the second pixel unit—the third pixel unit, and 0, where when the frame 2 uses a first sub pixel signal of the difference signals, a sub pixel signal combination of the frame 2 is that the second first pixel unit is equal to the first pixel unit—the third pixel unit, the second pixel unit is equal to 0, and the second third pixel unit is equal to 0.

In an embodiment of this application, the frame 3 is another sub pixel second signal of the difference, and a sub pixel signal combination of the frame 3 is that the third first pixel unit is equal to 0, the third second pixel unit is equal to the second pixel unit—the third pixel unit, and the third pixel unit is equal to 0.

In an embodiment of this application, the definition range based on hues and color saturation is a first condition range, a range based on magnitudes of zone average values is a second condition range, and therefore, the zone frame times are determined to adjust the corresponding first, second, and third light source luminance.

In an embodiment of this application, the first condition range and the second condition range of the definition range are selected from one of the following groups: a first group: when the hues in the first condition range are in an interval of 330° to 30°, and the color saturation is in an interval of first low saturation to first high saturation, and when in the second condition range, the first average signal is greater than the second average signal, and the second average signal is greater than the third average signal, a second frame third light source signal is adjusted as 0 or a second frame second light source signal is adjusted as 0, and third frame first and third light source signals are adjusted as 0; a second group: when the hues in the first condition range are in an interval of 330° to 30°, and the color saturation is in an interval of first low saturation to first high saturation, and when in the second condition range, the first average signal is greater than the third average signal, and the third average signal is greater than the second average signal, a second frame second light source signal is adjusted as 0 or a second frame third light source signal is adjusted as 0, and third frame first and second light source signals are adjusted as 0; a third group: when the hues in the first condition range are in an interval of 30° to 90°, and the color saturation is in an interval of second low saturation to second high saturation, and when in the second condition range, the first average signal is greater than the second average signal, and the second average signal is greater than the third average signal, a second frame third light source signal is adjusted as 0 or a second frame second light source signal is adjusted as 0, and third frame first and third light source signals are adjusted as 0; a fourth group: when the hues in the first condition range are in an interval of 90° to 150°, and the color saturation is in an interval of third low saturation to third high saturation, and when in the second condition range, the second average signal is greater than the first average signal, and the first average signal is greater than the third average signal, a second frame third light source signal is adjusted as 0 or a second frame first light source signal is adjusted as 0, and third frame second and third light source signals are adjusted as 0; a fifth group: when the hues in the first condition range are in an interval of 150° to 210°, and the color saturation is in an interval of fourth low saturation to fourth high saturation, and when in the second condition range, the second average signal is greater than the first average signal, and the first average signal is greater than the third average signal, a second frame third light source signal is adjusted as 0 or a second frame first light source signal is adjusted as 0, and third frame second and third light source signals are adjusted as 0; a sixth group: when the hues in the first condition range are in an interval of 150° to 210°, and the color saturation is in an interval of fourth low saturation to fourth high saturation, and when in the second condition range, the second average signal is greater than the third average signal, and the third average signal is greater than the first average signal, a second frame first light source signal is adjusted as 0 or a second frame third light source signal is adjusted as 0, and third frame first and second light source signals are adjusted as 0; a seventh group: when the hues in the first condition range are in an interval of 210° to 240°, and the color saturation is in an interval of fifth low saturation to fifth high saturation, and when in the second condition range, the second average signal is greater than the third average signal, and the third average signal is greater than the first average signal, a second frame first light source signal is adjusted as 0 or a second frame third light source signal is adjusted as 0, and third frame first and second light source signals are adjusted as 0; an eighth group: when the hues in the first condition range are in an interval of 210° to 240°, and the color saturation is in an interval of fifth low saturation to fifth high saturation, and when in the second condition range, the third average signal is greater than the second average signal, and the second average signal is greater than the first average signal, a second frame first light source signal is adjusted as 0 or a second frame second light source signal is adjusted as 0, and third frame first and third light source signals are adjusted as 0; a ninth group: when the hues in the first condition range are in an interval of 240° to 300°, and the color saturation is in an interval of sixth low saturation to sixth high saturation, and when in the second condition range, the third average signal is greater than the second average signal, and the second average signal is greater than the first average signal, a second frame first light source signal is adjusted as 0 or a second frame second light source signal is adjusted as 0, and third frame first and third light source signals are adjusted as 0; a tenth group: when the hues in the first condition range are in an interval of 240° to 300°, and the color saturation is in an interval of sixth low saturation to sixth high saturation, and when in the second condition range, the third average signal is greater than the first average signal, and the first average signal is greater than the second average signal, a second frame second light source signal is adjusted as 0 or a second frame first light source signal is adjusted as 0, and third frame second and third light source signals are adjusted as 0; an eleventh group: when the hues in the first condition range are in an interval of 300° to 330°, and the color saturation is in an interval of seventh low saturation to seventh high saturation, and when in the second condition range, the third average signal is greater than the first average signal, and the first average signal is greater than the second average signal, a second frame second light source signal is adjusted as 0 or a second frame first light source signal is adjusted as 0, and third frame second and third light source signals are adjusted as 0; and a twelfth group: when the hues in the first condition range are in an interval of 300° to 330°, and the color saturation is in an interval of seventh low saturation to seventh high saturation, and when in the second condition range, the first average signal is greater than the third average signal, and the third average signal is greater than the second average signal, a second frame second light source signal is adjusted as 0 or a second frame third light source signal is adjusted as 0, and third frame first and second light source signals are adjusted as 0.

In this application, by determining signals of first, second, and third sub pixel combinations, first, second, and third sub pixel input signals in each group are decomposed into three frame signals for presentation, need to be magnified to three times by cooperating with a drive frequency of a display, and respectively display three decomposed frame signals. The three decomposed frame signals improve luminance of a main color from a side viewing angle, and increase a ratio of a main color of the main sub pixel to side viewing angle luminance of an original frame low-voltage sub pixel, so that a color cast condition, affected by the low-voltage sub pixel, of the main color from the side viewing angle is improved, and it can be ensured to alleviate a color cast problem of a viewing angle and also enhance presentation of main signal luminance from the side viewing angle. The backlight luminance is improved to three times of original luminance to keep luminance of display of the first, second, and third sub pixel combinations by an overall picture quality unchanged. However, according to a combination of the average signals in the zone, a second frame displays only a color other than a color of the smallest average signal in the zone. Most sub pixel signals of sub pixels of the second frame are 0, and most are colors of the smallest average signals in the zone. Therefore, a color light source of first, second, and third of a backlight source whose most sub pixel signals are 0 when the zone displays the second frame may be closed. In addition, because the second frame displays only a combined signal of one color other than the color of the smallest average signal, the frame needs to display only a backlight signal of the color. Similarly, a third frame displays only a combined signal of the last color. Backlight luminance signals of different colors are provided to different frames, so as to save energy, and first, second, and third light source strength does not need to be enhanced to three times of original luminance all the time, which has smallest impact on presentation of picture quality or images and has functions of energy saving and improvement of color casts.

### BRIEF DESCRIPTION OF THE DRAWINGS

FIG. 1 is a diagram of a relationship between a color system and a color cast of an exemplary LCD before color cast adjustment;

FIG. 2 is a diagram of a relationship between a red cast and a grayscale of an LCD before color cast adjustment according to an embodiment of this application;

FIG. 3 is a diagram of a relationship between a green color cast and a grayscale of an LCD before color cast adjustment according to an embodiment of this application;

FIG. 4 is a diagram of a relationship between a blue cast and a grayscale of an LCD before color cast adjustment according to an embodiment of this application;

FIG. 5 is a diagram of a relationship between red X, green Y, and blue Z of red, green, and blue from a front viewing angle and a grayscale of an LCD before color cast adjustment according to an embodiment of this application;

FIG. 6 is a diagram of a relationship between red X, green Y, and blue Z of red, green, and blue from a large viewing angle and a grayscale of an LCD before color cast adjustment according to an embodiment of this application;

FIG. 7 is a schematic diagram of a device for driving a display device according to an embodiment of this application;

FIG. 8 is a schematic diagram of a color space system according to an embodiment of this application; and

FIG. 9 is a flowchart of a method for driving a display device according to an embodiment of this application.

### DETAILED DESCRIPTION

The following embodiments are described with reference to the accompanying drawings, and are used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, a size and a thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, in this specification, unless otherwise explicitly described to have an opposite meaning, the word “include” is understood as including the component, but not excluding any other component. In addition, in this specification, “on” means that a component is located above or below a target component and does not mean that the component needs to be located on the top based on a gravity direction.

To further describe the technical means used in this application to achieve the application objective and effects thereof, specific implementations, structures, features, and effects of a method for driving a display device and a drive device thereof provided according to this application are described in detail below with reference to the drawings and preferred embodiments.

A display device of this application includes a display panel and a backlight module that are disposed opposite to each other. The display panel mainly includes a color filter substrate, an active array substrate, and a liquid crystal layer sandwiched between the two substrates. The color filter substrate, the active array substrate, and the liquid crystal layer may form a plurality of pixel units configured in an array. The backlight module may emit light penetrating the display panel, and display colors by using each pixel unit of the display panel, to form an image.

In an embodiment, the display panel of this application may be a curved-surface display panel, and the display device of this application may also be a curved-surface display device.

Currently, in improvement of a wide viewing angle technology of a vertical alignment (VA) display panel, manufacturers of display devices have developed a photo-alignment technology to control an alignment direction of liquid crystal molecules, thereby improving optical performance and yield of a display panel. The photo-alignment technology is to form multi-domain alignment in each pixel unit of a panel, so that liquid crystal molecules in a pixel unit tilt towards, for example, four different directions. The photo-alignment technology is to irradiate a polymer thin film (an alignment layer) of a color filter substrate or a thin film transistor substrate by using an ultraviolet light source (for example, polarized light), so that polymer structures on a surface of the thin film perform non-homogeneous photopolymerization, isomerization, or pyrolysis, inducing chemical bond structures on the surface of the thin film generate special directivities, so as to further induce forward arrangement of liquid crystal molecules, thereby performing photo-alignment.

According to different orientation manners of liquid crystals, currently, display panels on a mainstream market may be divided into the following types: a VA type, a TN or super twisted nematic (STN) type, an in-plane switching (IPS) type, and a fringe field switching (FFS) type. Displays of a VA mode include, for example, a patterned vertical alignment (PVA) display or a multi-domain vertical alignment (MVA) display device. The PVA display achieves a wide viewing angle effect by using a fringing field effect and a compensation plate. The MVA display device divides one pixel into a plurality of areas, and makes, by using a protrusion or a particular pattern structure, liquid crystal molecules located in different areas tilt towards different directions, to achieve a wide viewing angle and improve a penetration transmittance. In an IPS mode or an FFS mode, by applying an electric field including components approximately parallel to a substrate, liquid crystal molecules make responses in a direction parallel to a plane of the substrate and are driven. An IPS display panel and an FFS display panel have advantages of wide viewing angles.

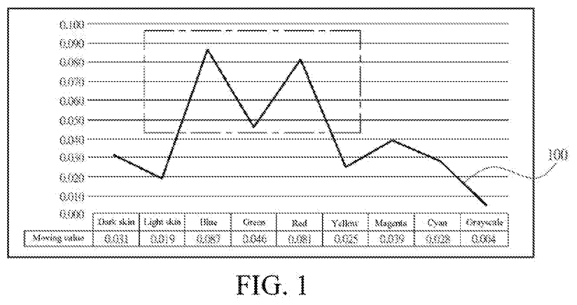

FIG. 1 is a diagram of a relationship between a color system and a color cast of an exemplary LCD before color cast adjustment. Referring to FIG. 1, in an LCD, due to correlation between a refractive index and a wavelength, transmittances of different wavelengths are related to phase delays of different wavelengths, so that transmittances and wavelengths have performance of different degrees. In addition, with drive of a voltage, phase delays of different wavelengths also generate changes of different degrees, affecting performance of transmittances of different wavelengths. FIG. 1 shows changes of color casts between large viewing angles and front viewing angles of various representative color systems of an LCD. It can be obviously found that conditions of color casts 100 of large viewing angles of color systems of red, green, and blue hues are all more severe than those of other color systems. Therefore, overcoming color cast defects of the red, green, and blue hues can greatly improve an overall color cast of a large viewing angle.

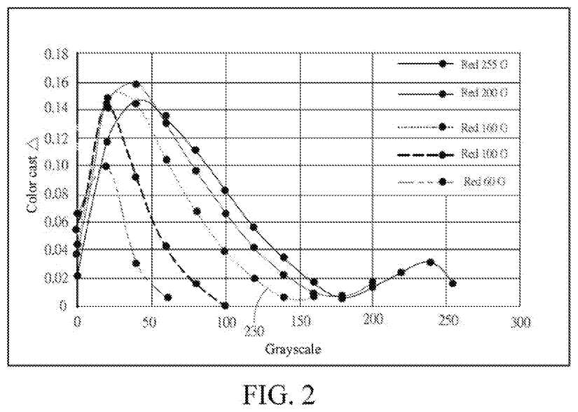

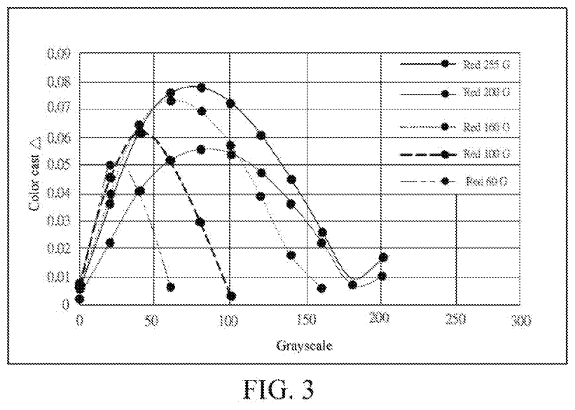

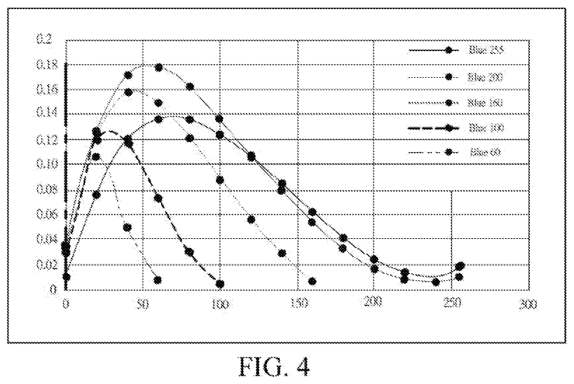

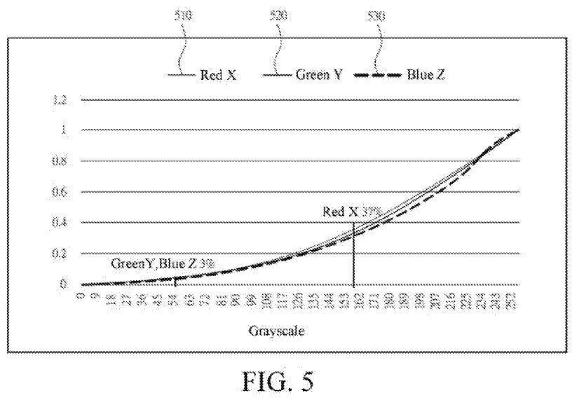

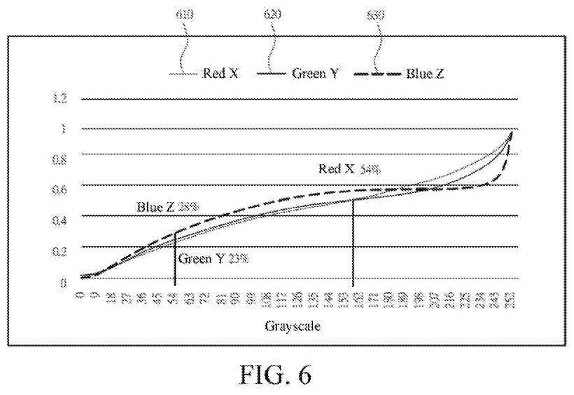

FIG. 2 is a diagram of a relationship between a red cast and a grayscale of an LCD before color cast adjustment according to an embodiment of this application; FIG. 3 is a diagram of a relationship between a green color cast and a grayscale of an LCD before color cast adjustment according to an embodiment of this application; FIG. 4 is a diagram of a relationship between a blue cast and a grayscale of an LCD before color cast adjustment according to an embodiment of this application; FIG. 5 is a diagram of a relationship between red X, green Y, and blue Z of red, green, and blue from a front viewing angle and a grayscale of an LCD before color cast adjustment according to an embodiment of this application; FIG. 6 is a diagram of a relationship between red X, green Y, and blue Z of red, green, and blue from a large viewing angle and a grayscale of an LCD before color cast adjustment according to an embodiment of this application. Referring to FIG. 2, FIG. 3, and FIG. 4, FIG. 2 shows viewing angle color difference change conditions of a front viewing angle and a 60° horizontal viewing angle under different color mixing conditions of a green system. As for changes of a color cast of a red hue combination, when a grayscale of a red curve 230 is 160, color mixing of red hues refers to that when green and blue signals are smaller than a red signal or are quite small with relative to a red signal, with increase in differences between green and red signals and between blue and red signals, a viewing angle color cast condition gradually becomes severe. Similarly, as for changes of a color cast of a green hue combination in FIG. 3, with increase in differences between red and green signals and between blue and green signals, a viewing angle color cast condition gradually becomes severe. As for changes of a color cast of a blue hue combination in FIG. 4, with increase in differences between red and blue signals and between green and blue signals, a viewing angle color cast condition gradually becomes severe.

Refer to FIG. 5, FIG. 6, and the following descriptions for reasons of a color cast. For example, a grayscale of a mixed color from a front viewing angle is red 160, green 50, and blue 50; and grayscale ratios of red X510, green Y520, blue Z530 to full grayscales red 255, green 255, and blue 255 from a corresponding front viewing angle are 37%, 3%, and 3% in color mixing, and grayscale ratios of red X610, green Y620, and blue Z630 to full grayscales red 255, green 255, and blue 255 from a corresponding large viewing angle are 54%, 23%, and 28% in color mixing. Ratios of red X, green Y, and blue Z in the mixed color from the front viewing angle are different from those of red X, green Y, and blue Z in a mixed color from the large viewing angle. Consequently, luminance ratios of green Y and blue Z to the red X from the original front viewing angle are considerably small, and luminance ratios of green Y and blue Z to the red X from the large viewing angle are non-neglectable. Therefore, a red hue from the large viewing angle is not as bright as a red hue from the front viewing angle, and has an obvious color cast.

Referring to descriptions for FIG. 2, as for changes of color casts of various red hue combinations, with increase in differences between green and red signals and between blue and red signals, a viewing angle color cast condition gradually becomes severe. The reason is, as stated above in FIG. 5 and FIG. 6, that luminance ratios 37%, 3%, and 3% of red, green, and blue from the front viewing angle are greatly different from luminance ratios 54%, 23%, and 28% of red, green, and blue from the large viewing angle. In addition, front viewing angle luminance of a lowered grayscale signal has a larger difference with side viewing angle luminance because of rapid saturation and improvement of the viewing angle luminance ratios of grayscale liquid crystal display. An existing international nation-suggested color cast value may be a color difference ≤0.02 and has relatively good liquid crystal display viewing angle observation characteristics. In this application, by subjecting original frame signals to multi-frame combination, luminance differences between mixed colors, red, green, and blue, from the front viewing angle and from the side viewing angle are reduced to present picture quality of low color cast display.

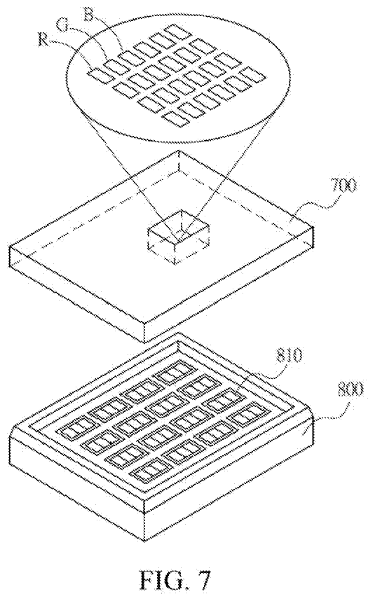

FIG. 7 is a schematic diagram of a device for driving a display device according to an embodiment of this application. Referring to FIG. 7, in an embodiment of this application, a device 800 for driving a display device includes a plurality of red, green, and blue sub pixels. Each group of red, green, and blue sub pixels is referred to as a pixel unit 810. Each pixel unit represents an image signal. In this application, a backlight source of red, green, and blue light-emitting diodes is divided into a plurality of zones. Each zone 700 includes a plurality of pixel units. Sizes of the zones may be self-defined. The backlight source and a display may be divided into a plurality of zones in columns*rows (N*M), and each zone has independent red, green, and blue light-emitting diode light sources. The device for driving a display device in this application includes: calculating average signals of sub pixel units in a zone 700 to obtain a zone red average signal, a zone green average signal, and a zone blue average signal; determining, according to the average signals in the zone, which hue of red, green, and blue is dominant in a lowest average signal sub pixel that a smallest average signal belongs to; determining that a smallest signal of most pixel units in the zone is a hue of a sub pixel of red, green, and blue; performing combined distribution of frame signals; calculating a color signal in average color space of pixel units of each zone and determining a range for an overall average color of the zone is; according to a definition range of hues and color saturation, determining zone frame times to adjust corresponding red, green, and blue light source luminance; and adjusting backlight luminance.

Referring to FIG. 7, in an embodiment, a device 800 for driving a display device includes at least one zone 700, where each zone 700 includes a plurality of pixel units, each pixel unit 810 includes a red sub pixel unit, a green sub pixel unit, and a blue sub pixel unit, and the device for driving a display device includes: calculating average signals of sub pixel units in a zone 700 to obtain a zone red average signal, a zone green average signal, and a zone blue average signal; determining, according to the average signals in the zone, which hue of red, green, and blue is dominant in a lowest average signal sub pixel that a smallest average signal belongs to; determining that a smallest signal of most pixel units in the zone is a hue of a sub pixel of red, green, and blue; performing combined distribution of frame signals; calculating a color signal in average color space of pixel units of each zone 700 and determining a range for an overall average color of the zone is; according to a definition range of hues and color saturation, determining zone frame times to adjust corresponding red, green, and blue light source luminance; and adjusting backlight luminance, where the definition range based on hues and color saturation is a first condition range, a range based on magnitudes of zone average values is a second condition range, and therefore, the zone frame times are determined to adjust the corresponding red, green, and blue light source luminance; the red sub pixel unit, the green sub pixel unit, and the blue sub pixel unit are arranged in an array.

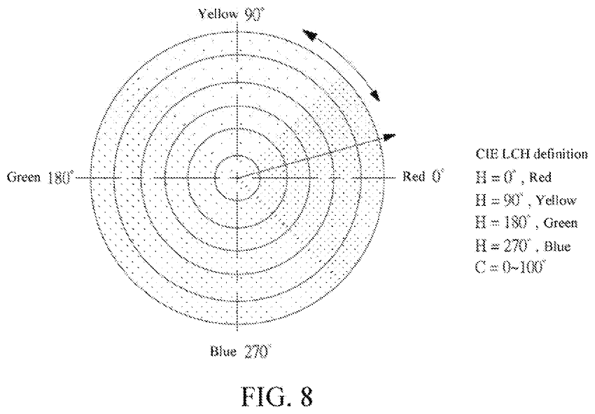

FIG. 8 is a schematic diagram of a color space system according to an embodiment of this application. Referring to FIG. 8, the color space system includes: a color coordinate system: luminance (L), saturation (C), hue (H) that is a function of red (R), green (G), and blue (B) three-color space coordinate with reference to the CIE standards, and luminance (L), saturation (C), hue (H) are respectively L=f1(R, G, B), C=f1(R, G, B), H=f1(R, G, B). H represents a color, and 0° to 360° represent presentation of different hue colors. It is defined that 0° is red, 90° is yellow, 180° is green, and 270° is blue. C is color purity and represents bright degrees of colors. A range of C is represented as from 0 to 100. 100 represents the most colorful and the brightest, and a value of C shows presentation of display of high and low voltage signals by an LCD in some extent.

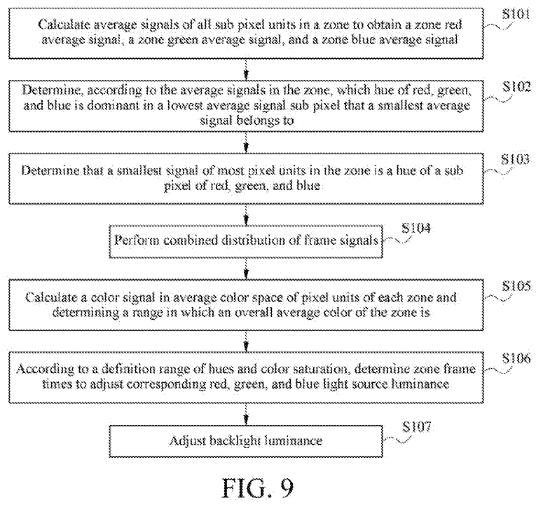

FIG. 9 is a flowchart of a method for driving a display device according to an embodiment of this application. Referring to FIG. 9, in an embodiment of this application, a method for driving a display device includes: calculating average signals of sub pixel units in a zone to obtain a zone red average signal, a zone green average signal, and a zone blue average signal; determining, according to the average signals in the zone, which hue of red, green, and blue is dominant in a lowest average signal sub pixel that a smallest average signal belongs to; determining that a smallest signal of most pixel units in the zone is a hue of a sub pixel of red, green, and blue; performing combined distribution of frame signals; calculating a color signal in average color space of pixel units of each zone and determining a range for an overall average color of the zone is; according to a definition range of hues and color saturation, determining zone frame times to adjust corresponding red, green, and blue light source luminance; and adjusting backlight luminance.

In an embodiment of this application, the average signals of pixel units in a zone are a red hue combination of the red average signal, the green average signal, and the blue average signal, and the red average signal is greater than the green average signal, and the green average signal is greater than the blue average signal; when a group of pixel units in the zone is a red hue combination of a red pixel unit, a green pixel unit, and a blue pixel unit, when a grayscale signal that the red pixel unit is greater than the green pixel unit, and the green pixel unit is greater than the blue pixel unit has a same order as a grayscale signal that the red average signal is greater than the green average signal, and the green average signal is greater than the blue average signal in the red hue combination of the average signals, that is, the red average signal, the green average signal, and the blue average signal, of the zone, a smallest common signal of the red pixel unit, the green pixel unit, and the blue pixel unit of the sub pixel unit is the blue pixel unit.

In an embodiment, the grayscale signal of the red pixel unit, the green pixel unit, and the blue pixel unit of the sub pixel unit turns into a signal combination of three frames from one frame, respectively, a frame 1 being a combination of a first red pixel unit, a first green pixel unit, and a first blue pixel unit, a frame 2 being a combination of a second red pixel unit, a second green pixel unit, and a second blue pixel unit, and a frame 3 being a combination of a third red pixel unit, a third green pixel unit, and a third blue pixel unit, where the signal combination of the frame 1, the frame 2, and the frame 3 satisfy that a sum of the first red pixel unit, the second red pixel unit, and the third red pixel unit is equal to the red pixel unit, a sum of the first green pixel unit, the second green pixel unit, and the third green pixel unit is equal to the green pixel unit, and a sum of the first blue pixel unit, the second blue pixel unit, and the third blue pixel unit is equal to the blue pixel unit.

In an embodiment, the combination 1 of the first red pixel unit, the first green pixel unit, and the first blue pixel unit of a sub pixel signal of the frame 1 uses a smallest color blue pixel unit pixel signal blue pixel unit of the sub pixel unit as a common sub pixel signal of the frame, that is, the first red pixel unit is equal to the blue pixel unit, the first green pixel unit is equal to the blue pixel unit, and the first blue pixel unit is equal to the blue pixel unit.

In an embodiment, the second red pixel unit, the second green pixel unit, and the second blue pixel unit of a sub pixel signal of the frame 2 are a sub pixel color of a common sub pixel signal of a difference between the red pixel unit, the green pixel unit, and the blue pixel unit of an original signal and the signal of the frame 1, that is, red, green, and blue sub pixel difference signals are respectively the red pixel unit—the blue pixel unit, the green pixel unit—the blue pixel unit, and 0, where when the frame 2 uses a red sub pixel signal of the difference signals, a sub pixel signal combination of the frame 2 is that the second red pixel unit is equal to the red pixel unit—the blue pixel unit, the second green pixel unit is equal to 0, and the second blue pixel unit is equal to 0.

In an embodiment, the frame 3 is another sub pixel green signal of the difference, and a sub pixel signal combination of the frame 3 is that the third red pixel unit is equal to 0, the third green pixel unit is equal to the green pixel unit—the blue pixel unit, and the third blue pixel unit is equal to 0.

In an embodiment, the definition range based on hues and color saturation is a first condition range, a range based on magnitudes of zone average values is a second condition range, and therefore, the zone frame times are determined to adjust the corresponding red, green, and blue light source luminance.

In an embodiment, the first condition range and the second condition range of the definition range are selected from one of the following groups: a first group: when the hues in the first condition range are in an interval of 330° to 30°, and the color saturation is in an interval of first low saturation to first high saturation, and when in the second condition range, the red average signal is greater than the green average signal, and the green average signal is greater than the blue average signal, a second frame blue light source signal is adjusted as 0 or a second frame green light source signal is adjusted as 0, and third frame red and blue light source signals are adjusted as 0; a second group: when the hues in the first condition range are in an interval of 330° to 30°, and the color saturation is in an interval of first low saturation to first high saturation, and when in the second condition range, the red average signal is greater than the blue average signal, and the blue average signal is greater than the green average signal, a second frame green light source signal is adjusted as 0 or a second frame blue light source signal is adjusted as 0, and third frame red and green light source signals are adjusted as 0; a third group: when the hues in the first condition range are in an interval of 30° to 90°, and the color saturation is in an interval of second low saturation to second high saturation, and when in the second condition range, the red average signal is greater than the green average signal, and the green average signal is greater than the blue average signal, a second frame blue light source signal is adjusted as 0 or a second frame green light source signal is adjusted as 0, and third frame red and blue light source signals are adjusted as 0; a fourth group: when the hues in the first condition range are in an interval of 90° to 150°, and the color saturation is in an interval of third low saturation to third high saturation, and when in the second condition range, the green average signal is greater than the red average signal, and the red average signal is greater than the blue average signal, a second frame blue light source signal is adjusted as 0 or a second frame red light source signal is adjusted as 0, and third frame green and blue light source signals are adjusted as 0; a fifth group: when the hues in the first condition range are in an interval of 150° to 210°, and the color saturation is in an interval of fourth low saturation to fourth high saturation, and when in the second condition range, the green average signal is greater than the red average signal, and the red average signal is greater than the blue average signal, a second frame blue light source signal is adjusted as 0 or a second frame red light source signal is adjusted as 0, and third frame green and blue light source signals are adjusted as 0; a sixth group: when the hues in the first condition range are in an interval of 150° to 210°, and the color saturation is in an interval of fourth low saturation to fourth high saturation, and when in the second condition range, the green average signal is greater than the blue average signal, and the blue average signal is greater than the red average signal, a second frame red light source signal is adjusted as 0 or a second frame blue light source signal is adjusted as 0, and third frame red and green light source signals are adjusted as 0; a seventh group: when the hues in the first condition range are in an interval of 210° to 240°, and the color saturation is in an interval of fifth low saturation to fifth high saturation, and when in the second condition range, the green average signal is greater than the blue average signal, and the blue average signal is greater than the red average signal, a second frame red light source signal is adjusted as 0 or a second frame blue light source signal is adjusted as 0, and third frame red and green light source signals are adjusted as 0; an eighth group: when the hues in the first condition range are in an interval of 210° to 240°, and the color saturation is in an interval of fifth low saturation to fifth high saturation, and when in the second condition range, the blue average signal is greater than the green average signal, and the green average signal is greater than the red average signal, a second frame red light source signal is adjusted as 0 or a second frame green light source signal is adjusted as 0, and third frame red and blue light source signals are adjusted as 0; a ninth group: when the hues in the first condition range are in an interval of 240° to 300°, and the color saturation is in an interval of sixth low saturation to sixth high saturation, and when in the second condition range, the blue average signal is greater than the green average signal, and the green average signal is greater than the red average signal, a second frame red light source signal is adjusted as 0 or a second frame green light source signal is adjusted as 0, and third frame red and blue light source signals are adjusted as 0; a tenth group: when the hues in the first condition range are in an interval of 240° to 300°, and the color saturation is in an interval of sixth low saturation to sixth high saturation, and when in the second condition range, the blue average signal is greater than the red average signal, and the red average signal is greater than the green average signal, a second frame green light source signal is adjusted as 0 or a second frame red light source signal is adjusted as 0, and third frame green and blue light source signals are adjusted as 0; an eleventh group: when the hues in the first condition range are in an interval of 300° to 330°, and the color saturation is in an interval of seventh low saturation to seventh high saturation, and when in the second condition range, the blue average signal is greater than the red average signal, and the red average signal is greater than the green average signal, a second frame green light source signal is adjusted as 0 or a second frame red light source signal is adjusted as 0, and third frame green and blue light source signals are adjusted as 0; and a twelfth group: when the hues in the first condition range are in an interval of 300° to 330°, and the color saturation is in an interval of seventh low saturation to seventh high saturation, and when in the second condition range, the red average signal is greater than the blue average signal, and the blue average signal is greater than the green average signal, a second frame green light source signal is adjusted as 0 or a second frame blue light source signal is adjusted as 0, and third frame red and green light source signals are adjusted as 0.

Referring to FIG. 9, Flow S101: Calculate average signals of sub pixel units in a zone to obtain a zone red average signal, a zone green average signal, and a zone blue average signal.

Referring to FIG. 9, Flow S102: Determine, according to the average signals in the zone, which hue of red, green, and blue is dominant in a lowest average signal sub pixel that a smallest average signal belongs to.

Referring to FIG. 9, Flow S103: Determine that a smallest signal of most pixel units in the zone is a hue of a sub pixel of red, green, and blue.

Referring to FIG. 9, Flow S104: Perform combined distribution of frame signals.

Referring to FIG. 9, Flow S105: Calculate a color signal in average color space of pixel units of each zone and determining a range for an overall average color of the zone is.

Referring to FIG. 9, Flow S106: According to a definition range of hues and color saturation, determine zone frame times to adjust corresponding red, green, and blue light source luminance.

Referring to FIG. 9, Flow S107: Adjust backlight luminance.

In an embodiment, a red hue combination of sub pixel units R_{i,j}, G_{i,j}, and B_{i,j} (i and j are a group of R, G, and B pixel units in a display area) in the display area when, for example, R_{i,j}=100, G_{i,j}=80, and B_{i,j}=40. A smallest common signal of R_{i,j}, G_{i,j}, and B_{i,j} has a grayscale of 40. Therefore, a grayscale signal of R_{i,j}, G_{i,j}, and B_{i,j} turns into three combinations, that is, a combination 1 of R1_{i,j}, G1_{i,j}, and B1_{i,j}, a combination 2 of R2_{i,j}, G2_{i,j}, and B2_{i,j}, and a combination 3 of R3_{i,j}, G3_{i,j}, and B3_{i,j}. The combination 1 of R1_{i,j}, G1_{i,j}, and B1_{i,j} is the smallest common signal having a grayscale of 40, that is, R1_{i,j}=40, G1_{i,j}=40, and B1_{i,j}=40. The combination 2 of R2_{i,j}, G2_{i,j}, and B2_{i,j} is one color of a difference between an original signal and the signal of the combination 1. As described above, the combination 2 may be R2_{i,j}=60, G2_{i,j}=0, B2_{i,j}=0 or R2_{i,j}=0, G2_{i,j}=40, B2_{i,j}=0, and the combination 3 is a remaining last signal, that is, R3_{i,j}=0, G3_{i,j}=40, B3_{i,j}=0 or R3_{i,j}=60, G3_{i,j}=0, B3_{i,j}=0. In addition to that the combination 1 is the common signal, a color sequence of the combinations 2 and 3 may be preferentially presented by any one color of the remaining signal.

In an embodiment, the original sub pixel signal turns into a signal combination of three frames from R_{i,j}, G_{i,j}, and B_{i,j}, and the combination of three groups of frame signals is presented in time in a sequence. That is, the original frame signals need to be turned to three times. The combination 1 of R1_{i,j}, G1_{i,j}, and B1_{i,j} is presented at a time, the combination 2 of R2_{i,j}, G2_{i,j}, and B2_{i,j} is presented at another time, and the combination 3 of R3_{i,j}, G3_{i,j}, and B3 is presented at still another time.

Referring to FIG. 5 and FIG. 6, in an embodiment, assuming that front viewing angle luminance ratios of the original frame signals R_{i,j}=100, G_{i,j}=80, and B_{i,j}=40 to a full grayscale signal Gray 255 are SR %, LG %, and MB %, side viewing angle luminance is SR′ %, LG′ %, and MB′ % correspondingly. SR is greater than LG, and LG is greater than MB, and SR′ is greater than LG′, and LG′ is greater than MB′. However, as stated above, front viewing angle luminance of a lowered grayscale signal has a larger difference with side viewing angle luminance. Therefore, it can be learnt that SR/MB is greater than SR′/MB′, and LG/MB is greater than LG′/MB′. In this way, color mixing makes that luminance of a main luminance signal SR from the front viewing angle is greatly different from that of an MB signal, but luminance of a main luminance signal SR′ from the large viewing angle is slightly different from that of an MB′ signal. A viewing angle main color is affected, and color brightness thereof drops. Referring to FIG. 5, SR %=13.3%, LG %=8%, MB=1.8%. Referring to FIG. 6, SR′ %=40%, LG′ %=33%, MB′=17%.

Referring to FIG. 5 and FIG. 6, in an embodiment, frame combinations are used. In the combination 1 of R1_{i,j}, G1_{i,j}, and B1_{i,j}, because signals all have a grayscale of 40, it can be assumed that ratios of front viewing angle luminance of R1_{i,j}, G1_{i,j}, and B1_{i,j} in FIG. 5 in the frame are 1.8%, 1.8%, and 1.8%, and ratios of side viewing angle luminance in FIG. 6 are correspondingly 17%, 17%, 17%. Ratios of front viewing angle luminance of the combination 2 R2_{i,j}=60, G2_{i,j}=0, and B2_{i,j}=0 in FIG. 5 in the frame are 3.8%, 0%, and 0%, and ratios of side viewing angle luminance in FIG. 6 are correspondingly 26.8%, 0%, 0%. Ratios of front viewing angle luminance of the combination 3 R3_{i,j}=0, G3_{i,j}=40, and B3_{i,j}=0 in FIG. 5 in the frame are 0%, 1.8%, and 0%, and ratios of side viewing angle luminance in FIG. 6 are correspondingly 0%, 17%, 0%. Color mixing ratios of the frame 1, the frame 2, and the frame 3 from the side viewing angle are R_{i,j}:G_{i,j}:B_{i,j}, that is, 17%+26.8%+0%=43.8%, 17%+0%+17%=34%, and 17%+0%+0%=17%. Ratios of side viewing angle luminance of the original frames are R_{i,j}:G_{i,j}:B_{i,j} 38%, 30%, 17%. Apparently, a main color R is improved from 40/17=2.35 in the original frames to 43.8/17=2.57 of the combined frame relative to the luminance ratio of B. A ratio of a main color pixel to other colors is apparently improved, so that a viewing angle is presented in a manner of approaching a main color from the front viewing angle.

In an embodiment, other sub pixel unit combinations R′ i,j, G′ i,j, and B′ i,j (i and j are one group of R, G, and B pixel units in the display area) exist in the zone, for example, a green hue combination when R′ i,j=A2, G′ i,j=B2, B′ i,j=C2. It is assumed that a grayscale signal that B2 is greater than C2, and C2 is greater than A2 has a different order with a grayscale signal that A is greater than B, and B is greater than C in a hue combination of the average signals, that is, the red average signal=A, the green average signal=B, and the blue average signal=C, of the zone.

In an embodiment, a smallest common signal of R′_{i,j}, G′_{i,j}, and B′_{i,j} is, for example, A2. The grayscale signal of the sub pixel units R′_{i,j}, G′_{i,j}, and B′_{i,j} turns into three grayscale frames, respectively a frame combination 1 of R′ 1_{i,j}, G′ 1_{i,j}, and B′ 1_{i,j}, a frame combination 2 of R′ 2_{i,j}, G′ 2_{i,j}, and B′ 2_{i,j}, and a frame combination 3 of R′ 3_{i,j}, G′ 3_{i,j}, and B′ 3_{i,j}. The signal combination of the frame 1, the frame 2, and the frame 3 satisfies that R′ 1_{i,j}+R′ 2_{i,j}+R′ 3_{i,j}=R′_{i,j}, G′ 1_{i,j}+G′ 2_{i,j}+G′ 3_{i,j}=G′_{i,j}, B′ 1_{i,j}+B′ 2_{i,j}+B′ 3_{i,j}=B′_{iJ}. The combination 1 of R′ 1_{i,j}, G′ 1_{i,j}, and B′ 1_{i,j} uses a smallest color R′_{i,j} pixel signal A2 of the sub pixel unit as a common sub pixel signal of the frame, that is, R′_{i,j}=A2, G′ 1_{i,j}=A2, and B′ 1_{i,j}=A2. The sub pixel signals R2_{i,j}, G2_{i,j}, and B2_{i,j} of the frame 2 are a sub pixel color of a common sub pixel signal of a difference between R_{i,j}, G_{i,j}, and B_{i,j} of an original signal and the signal of the frame 1, that is, R, G, and B sub pixel difference signals are respectively 0, B2-A2, and C2-A2. The frame 2 uses a sub pixel signal of the difference signals, and the frame 3 uses another sub pixel signal of the difference. If the frame 2 uses a red sub pixel signal of the difference signals, a sub pixel signal combination of the frame 2 is R2_{i,j}=0, G2_{i,j}=0, and B2_{i,j}=C2-A2. The frame 2 is another sub pixel green signal of the difference, and a sub pixel signal combination of the frame 3 is R3_{i,j}=0, G2=B2-A2, and B2_{i,j}=0.

In an embodiment, in a red hue combination of the red average signal=A, the green average signal=B, and the blue average signal=C in average signals in a zone, combinations of most sub pixels in the zone are all grayscale signals satisfying that R′_{i,j} is greater than G′_{i,j}, and G′_{i,j} is greater than B′_{i,j}, and a combination of signals of R1_{i,j}=A1, G1_{i,j}=B1, and B1_{i,j}=C1 of the frame 1 of most sub pixel units in the zone is a smallest common signal C1. Therefore, signals of most B2_{i,j} of sub pixels of the second frame combination are 0, and the frame displays only a sub pixel color of the common sub pixel signal of the difference between R_{i,j}, G_{i,j}, and B_{i,j} of the original signal and the signal of the frame 1. If the frame 2 displays using a red sub pixel signal of the difference signals, a sub pixel green signal of the frame 2 is separately displayed in the frame 3. Therefore, when the second frame is displayed in the zone, backlight source green and blue light-emitting diode light sources are closed. In this way, a signal of B′ 2_{i,j}=C2-A2 of the frame combination 2 of a green hue combination (B2 is greater than C2, and C2 is greater than A2) of R′_{i,j}=A2, G′_{i,j}=B2, and B′_{i,j}=C2 described above of the signal cannot pass through a blue light-emitting diode light source to be normally presented when the sub pixel in the zone does not satisfy that R′_{i,j} is greater than G′_{i,j}, and G′_{i,j} is greater than B′_{i,j}. However, it can be predicted that the average signals in the zone are a red hue combination of the red average signal=A, the green average signal=B, and the blue average signal=C, most sub pixel combinations are grayscale signals that A is greater than B, and B is greater than C, and other combination situations are relatively few. Therefore, the second frame signal of the sub pixel does not present that few B′_{i,j} compensation signals do not have much impact on an overall color or picture quality The sub pixel signal of the third frame combination 3 displays only a green signal, and signals of G2_{i,j} and B2_{i,j} are 0. Therefore, backlight source red and blue light emitting diode light sources when the zone displays the third frame may be closed.

In this application, by determining signals of red, green, and blue sub pixel combinations, red, green, and blue sub pixel input signals in each group are decomposed into three frame signals for presentation, need to be magnified to three times by cooperating with a drive frequency of a display, and respectively display three decomposed frame signals. The three decomposed frame signals improve luminance of a main color from a side viewing angle, and increase a ratio of a main color of the main sub pixel to side viewing angle luminance of an original frame low-voltage sub pixel, so that a color cast condition, affected by the low-voltage sub pixel, of the main color from the side viewing angle is improved, and it can be ensured to alleviate a color cast problem of a viewing angle and also enhance presentation of main signal luminance from the side viewing angle. The backlight luminance is improved to three times of original luminance to keep luminance of display of the red, green, and blue sub pixel combinations by an overall picture quality unchanged. However, according to a combination of the average signals in the zone, a second frame displays only a color other than a color of the smallest average signal in the zone. Most sub pixel signals of sub pixels of the second frame are 0, and most are colors of the smallest average signals in the zone. Therefore, a color light source of red, green, and blue of a backlight source whose most sub pixel signals are 0 when the zone displays the second frame may be closed. In addition, because the second frame displays only a combined signal of one color other than the color of the smallest average signal, the frame needs to display only a backlight signal of the color. Similarly, a third frame displays only a combined signal of the last color. Backlight luminance signals of different colors are provided to different frames, so as to save energy, and red, green, and blue light source strength does not need to be enhanced to three times of original luminance all the time, which has smallest impact on presentation of picture quality or images and has functions of energy saving and improvement of color casts.

The wordings such as “in some embodiments” and “in various embodiments” are repeatedly used. The phrases usually refer to different embodiments, but they may also refer to a same embodiment. The words, such as “comprise”, “have”, and “include”, are synonyms, unless other meanings are indicated in the context thereof.

Descriptions above are merely specific embodiments of this application, and are not intended to limit this application. Although this application has been disclosed above in forms of specific embodiments, the embodiments are not intended to limit this application. A person skilled in the art can make some equivalent variations, alterations or modifications to the above disclosed technical content without departing from the scope of the technical solutions of the above disclosed technical content to obtain equivalent embodiments. Any simple alteration, equivalent change or modification made to the foregoing embodiments according to the technical essence of this application without departing from the content of the technical solutions of this application shall fall within the scope of the technical solutions of this application.

What is claimed is:

1. A method for driving a display device, comprising:
calculating average signals of sub pixel units in a zone to obtain a zone first average signal, a zone second average signal, and a zone third average signal;
determining, according to the average signals in the zone, a smallest average signal as a lowest average signal sub pixel in terms of a dominant hue out of first, second, and third hues;
determining that a smallest signal of most pixel units in the zone is a hue of a sub pixel of first, second, and third;
performing combined distribution of frame signals;
calculating a color signal in average color space of pixel units of each zone and determining a range for an overall average color of the zone;
according to a definition range of hues and color saturation, determining zone frame times to adjust corresponding first, second, and third light source luminance; and
adjusting backlight luminance.

2. The method for driving a display device according to claim 1, wherein the average signals of pixel units in a zone are a first hue combination of the first average signal, the second average signal, and the third average signal.

3. The method for driving a display device according to claim 2, wherein the first average signal is greater than the second average signal, and the second average signal is greater than the third average signal.

4. The method for driving a display device according to claim 2, wherein when a group of pixel units in the zone is a first hue combination of a first pixel unit, a second pixel unit, and a third pixel unit, when a grayscale signal that the first pixel unit is greater than the second pixel unit, and the second pixel unit is greater than the third pixel unit has a same order as a grayscale signal that the first average signal is greater than the second average signal, and the second average signal is greater than the third average signal in the first hue combination of the average signals, that is, the first average signal, the second average signal, and the third average signal, of the zone, a smallest common signal of the first pixel unit, the second pixel unit, and the third pixel unit of the sub pixel unit is the third pixel unit.

5. The method for driving a display device according to claim 2, wherein the grayscale signal of the first pixel unit, the second pixel unit, and the third pixel unit of the sub pixel unit turns into a signal combination of three frames from one frame, respectively, a frame 1 being a combination of a first pixel unit, a first second pixel unit, and a first third pixel unit, a frame 2 being a combination of a second first pixel unit, a second pixel unit, and a second third pixel unit, and a frame 3 being a combination of a third first pixel unit, a third second pixel unit, and a third pixel unit, wherein the signal combination of the frame 1, the frame 2, and the frame 3 satisfy that a sum of the first pixel unit, the second first pixel unit, and the third first pixel unit is equal to the first pixel unit, a sum of the first second pixel unit, the second pixel unit, and the third second pixel unit is equal to the second pixel unit, and a sum of the first third pixel unit, the second third pixel unit, and the third pixel unit is equal to the third pixel unit.

6. The method for driving a display device according to claim 5, wherein the combination 1 of the first pixel unit, the first second pixel unit, and the first third pixel unit of a sub pixel signal of the frame 1 uses a smallest color third pixel unit pixel signal third pixel unit of the sub pixel unit as a common sub pixel signal of the frame, that is, the first pixel unit is equal to the third pixel unit, the first second pixel unit is equal to the third pixel unit, and the first third pixel unit is equal to the third pixel unit.

7. The method for driving a display device according to claim 5, wherein the second first pixel unit, the second pixel unit, and the second third pixel unit of a sub pixel signal of the frame 2 are a sub pixel color of a common sub pixel signal of a difference between the first pixel unit, the second pixel unit, and the third pixel unit of an original signal and the signal of the frame 1, that is, first, second, and third sub pixel difference signals are respectively the first pixel unit—the third pixel unit, the second pixel unit—the third pixel unit, and 0, wherein when the frame 2 uses a first sub pixel signal of the difference signals, a sub pixel signal combination of the frame 2 is that the second first pixel unit is equal to the first pixel unit—the third pixel unit, the second pixel unit is equal to 0, and the second third pixel unit is equal to 0.

8. The method for driving a display device according to claim 5, wherein the frame 3 is another sub pixel second signal of the difference, and a sub pixel signal combination of the frame 3 is that the third first pixel unit is equal to 0, the third second pixel unit is equal to the second pixel unit—the third pixel unit, and the third pixel unit is equal to 0.

9. The method for driving a display device according to claim 1, wherein the definition range based on hues and color saturation is a first condition range, a range based on magnitudes of zone average values is a second condition range, and therefore, the zone frame times are determined to adjust the corresponding first, second, and third light source luminance.

10. The method for driving a display device according to claim 9, wherein the first condition range and the second condition range of the definition range are selected from one of the following groups:
a first group: when the hues in the first condition range are in an interval of 330° to 30°, and the color saturation is in an interval of first low saturation to first high saturation, and when in the second condition range, the first average signal is greater than the second average signal, and the second average signal is greater than the third average signal, a second frame third light source signal is adjusted as 0 or a second frame second light source signal is adjusted as 0, and third frame first and third light source signals are adjusted as 0;
a second group: when the hues in the first condition range are in an interval of 330° to 30°, and the color saturation is in an interval of first low saturation to first high saturation, and when in the second condition range, the first average signal is greater than the third average signal, and the third average signal is greater than the second average signal, a second frame second light source signal is adjusted as 0 or a second frame third light source signal is adjusted as 0, and third frame first and second light source signals are adjusted as 0;
a third group: when the hues in the first condition range are in an interval of 30° to 90°, and the color saturation is in an interval of second low saturation to second high saturation, and when in the second condition range, the first average signal is greater than the second average signal, and the second average signal is greater than the third average signal, a second frame third light source signal is adjusted as 0 or a second frame second light source signal is adjusted as 0, and third frame first and third light source signals are adjusted as 0;
a fourth group: when the hues in the first condition range are in an interval of 90° to 150°, and the color saturation is in an interval of third low saturation to third high saturation, and when in the second condition range, the second average signal is greater than the first average signal, and the first average signal is greater than the third average signal, a second frame third light source signal is adjusted as 0 or a second frame first light source signal is adjusted as 0, and third frame second and third light source signals are adjusted as 0;
a fifth group: when the hues in the first condition range are in an interval of 150° to 210°, and the color saturation is in an interval of fourth low saturation to fourth high saturation, and when in the second condition range, the second average signal is greater than the first average signal, and the first average signal is greater than the third average signal, a second frame third light source signal is adjusted as 0 or a second frame first light source signal is adjusted as 0, and third frame second and third light source signals are adjusted as 0;
a sixth group: when the hues in the first condition range are in an interval of 150° to 210°, and the color saturation is in an interval of fourth low saturation to fourth high saturation, and when in the second condition range, the second average signal is greater than the third average signal, and the third average signal is greater than the first average signal, a second frame first light source signal is adjusted as 0 or a second frame third light source signal is adjusted as 0, and third frame first and second light source signals are adjusted as 0;
a seventh group: when the hues in the first condition range are in an interval of 210° to 240°, and the color saturation is in an interval of fifth low saturation to fifth high saturation, and when in the second condition range, the second average signal is greater than the third average signal, and the third average signal is greater than the first average signal, a second frame first light source signal is adjusted as 0 or a second frame third light source signal is adjusted as 0, and third frame first and second light source signals are adjusted as 0;
an eighth group: when the hues in the first condition range are in an interval of 210° to 240°, and the color saturation is in an interval of fifth low saturation to fifth high saturation, and when in the second condition range, the third average signal is greater than the second average signal, and the second average signal is greater than the first average signal, a second frame first light source signal is adjusted as 0 or a second frame second light source signal is adjusted as 0, and third frame first and third light source signals are adjusted as 0;
a ninth group: when the hues in the first condition range are in an interval of 240° to 300°, and the color saturation is in an interval of sixth low saturation to sixth high saturation, and when in the second condition range, the third average signal is greater than the second average signal, and the second average signal is greater than the first average signal, a second frame first light source signal is adjusted as 0 or a second frame second light source signal is adjusted as 0, and third frame first and third light source signals are adjusted as 0;
a tenth group: when the hues in the first condition range are in an interval of 240° to 300°, and the color saturation is in an interval of sixth low saturation to sixth high saturation, and when in the second condition range, the third average signal is greater than the first average signal, and the first average signal is greater than the second average signal, a second frame second light source signal is adjusted as 0 or a second frame first light source signal is adjusted as 0, and third frame second and third light source signals are adjusted as 0;
an eleventh group: when the hues in the first condition range are in an interval of 300° to 330°, and the color saturation is in an interval of seventh low saturation to seventh high saturation, and when in the second condition range, the third average signal is greater than the first average signal, and the first average signal is greater than the second average signal, a second frame second light source signal is adjusted as 0 or a second frame first light source signal is adjusted as 0, and third frame second and third light source signals are adjusted as 0; and
a twelfth group: when the hues in the first condition range are in an interval of 300° to 330°, and the color saturation is in an interval of seventh low saturation to seventh high saturation, and when in the second condition range, the first average signal is greater than the third average signal, and the third average signal is greater than the second average signal, a second frame second light source signal is adjusted as 0 or a second frame third light source signal is adjusted as 0, and third frame first and second light source signals are adjusted as 0.

11. A device for driving a display device, comprising at least one zone, wherein each zone comprises a plurality of pixel units, each pixel unit comprises a first sub pixel unit, a second sub pixel unit, and a third sub pixel unit, and the device for driving a display device comprises:
calculating average signals of sub pixel units in a zone to obtain a zone first average signal, a zone second average signal, and a zone third average signal;
determining, according to the average signals in the zone, a smallest average signal as a lowest average signal sub pixel in terms of a dominant hue out of first, second, and third hues;
determining that a smallest signal of most pixel units in the zone is a hue of a sub pixel of first, second, and third;
performing combined distribution of frame signals;
calculating a color signal in average color space of pixel units of each zone and determining a range for an overall average color of the zone is;
according to a definition range of hues and color saturation, determining zone frame times to adjust corresponding first, second, and third light source luminance; and
adjusting backlight luminance.

12. The device for driving a display device according to claim 11, wherein the definition range based on hues and color saturation is a first condition range, a range based on magnitudes of zone average values is a second condition range, and therefore, the zone frame times are determined to adjust the corresponding first, second, and third light source luminance.

13. The device for driving a display device according to claim 11, wherein the first sub pixel unit, the second sub pixel unit, and the third sub pixel unit are arranged in an array.

14. The device for driving a display device according to claim 11, wherein the average signals of pixel units in a zone are a first hue combination of the first average signal, the second average signal, and the third average signal.

15. The device for driving a display device according to claim 14, wherein the first average signal is greater than the second average signal, and the second average signal is greater than the third average signal.

16. The device for driving a display device according to claim 12, wherein when a group of pixel units in the zone is a first hue combination of a first pixel unit, a second pixel unit, and a third pixel unit, when a grayscale signal that the first pixel unit is greater than the second pixel unit, and the second pixel unit is greater than the third pixel unit has a same order as a grayscale signal that the first average signal is greater than the second average signal, and the second average signal is greater than the third average signal in the first hue combination of the average signals, that is, the first average signal, the second average signal, and the third average signal, of the zone, a smallest common signal of the first pixel unit, the second pixel unit, and the third pixel unit of the sub pixel unit is the third pixel unit.

17. The device for driving a display device according to claim 12, wherein the grayscale signal of the first pixel unit, the second pixel unit, and the third pixel unit of the sub pixel unit turns into a signal combination of three frames from one frame, respectively, a frame 1 being a combination of a first pixel unit, a first second pixel unit, and a first third pixel unit, a frame 2 being a combination of a second first pixel unit, a second pixel unit, and a second third pixel unit, and a frame 3 being a combination of a third first pixel unit, a third second pixel unit, and a third pixel unit.

18. The device for driving a display device according to claim 17, wherein the signal combination of the frame 1, the frame 2, and the frame 3 satisfy that a sum of the first pixel unit, the second first pixel unit, and the third first pixel unit is equal to the first pixel unit, a sum of the first second pixel unit, the second pixel unit, and the third second pixel unit is equal to the second pixel unit, and a sum of the first third pixel unit, the second third pixel unit, and the third pixel unit is equal to the third pixel unit.

19. The device for driving a display device according to claim 18, wherein the combination 1 of the first pixel unit, the first second pixel unit, and the first third pixel unit of a sub pixel signal of the frame 1 uses a smallest color third pixel unit pixel signal third pixel unit of the sub pixel unit as a common sub pixel signal of the frame, that is, the first pixel unit is equal to the third pixel unit, the first second pixel unit is equal to the third pixel unit, and the first third pixel unit is equal to the third pixel unit.

20. A device for driving a display device, comprising at least one zone, wherein each zone comprises a plurality of pixel units, each pixel unit comprises a first sub pixel unit, a second sub pixel unit, and a third sub pixel unit, and the device for driving a display device comprises:
calculating average signals of sub pixel units in a zone to obtain a zone first average signal, a zone second average signal, and a zone third average signal;
determining, according to the average signals in the zone, a smallest average signal as a lowest average signal sub pixel in terms of a dominant hue out of first, second, and third hues;
determining that a smallest signal of most pixel units in the zone is a hue of a sub pixel of first, second, and third;
performing combined distribution of frame signals;
calculating a color signal in average color space of pixel units of each zone and determining a range for an overall average color of the zone is;
according to a definition range of hues and color saturation, determining zone frame times to adjust corresponding first, second, and third light source luminance; and
adjusting backlight luminance, wherein the definition range based on hues and color saturation is a first condition range, a range based on magnitudes of zone average values is a second condition range, and therefore, the zone frame times are determined to adjust the corresponding first, second, and third light source luminance; the first sub pixel unit, the second sub pixel unit, and the third sub pixel unit are arranged in an array.
